(19) United States
(12) Patent Application Publication
(10) Pub. No.: US 2005/0153259 A1
(43) Pub. Date: Jul. 14, 2005

(54) Capped syringe tip for dispensing and applying liquid or viscous materials

(76) Inventors: Thomas C. Simonton, Mount Wolf, PA (US); Kenneth S. Peterson, Lancaster, PA (US)

Correspondence Address: Douglas J. Hura, Esquire;DENTSPLY International Inc., 570 West College Avenue, P.O. Box 872, York, PA, 17405-0872, US

(21) Appl. No.: 11/075,636

(22) Filed: Mar. 8, 2005

Related U.S. Application Data
(63) Continuation of application No. 10/431,931, filed on May 8, 2003, now abandoned.
(60) Provisional application No. 60/378,816, filed on May 8, 2002.

(51) Int. Cl. A61C 5/04

(52) U.S. Cl. 433/89; 604/187

(57) ABSTRACT

A tip (10) for the dispensing of a material such as from a syringe (31) has an inlet end (11) and an outlet end (12) and a body (13). The tip (10) is also provided with a cap (50) that physically engages and cooperates with at least one nub (51) to improve the removable securing of the cap (50) to the tip (10). The cap (50) covers the outlet end (12) and has an interior surface (52) dimensioned to physically contact the nubs (51) when in place upon the tip (10).

### RELATED APPLICATIONS

This is a continuation application of pending U.S. patent application Ser. No. 10/431,931 (Case DPD-123) filed on May 8, 2003; which claims priority of U.S. provisional patent application Ser. No. 60/378,816 (Case DPD-123) filed on May 8, 2002.

### TECHNICAL FIELD

The present invention is generally directed toward the dispensing of viscous materials with the use of a syringe. More particularly, the invention relates to a syringe tip used for the dispensing of such materials. Specifically, the invention relates a capped syringe tip.

### BACKGROUND OF THE INVENTION

It is known to dispense viscous materials, such as dental materials, from a syringe. Often the syringes are either the type having a piston that is pushed through a barrel, or those wherein a thumbscrew is turned to advance a piston. However, the term “syringe” can also encompass other similar deliver devices including those where a lever is depressed to advance a piston as in U.S. Pat. No. 4,708,650, or the type where a “trigger” is depressed in a gun-type applicator as in U.S. Pat. No. 5,707,234, and the like. While the present invention has particular application to traditional dispensing syringes, it will be understood that its use is not thereby constrained.

The dispensing syringe is often fitted at one end with a tip used to direct the flow of material as it is expressed from the syringe. For example, DENTSPLY International Inc. of York, Pa. markets tooth whiteners, dental restoratives, etchants and sealants in syringes. Efforts have been made to improve the efficacy of the syringe tips. For example, U.S. Pat. Nos. 4,391,590, 4,768,954, 5,816,804, 6,059,570 and 6,083,002 all disclose tip designs. It is known to affix a brush of flocculent to the dispensing or outlet end of the tip to aid in subsequent application of the dispensed material.

It is especially the case with volatile dental materials, that premature exposure to the ambient environment may be detrimental to the product. Dental materials are often light cured, self-cured or are otherwise affected by exposure to ambient conditions. Such materials are often of low viscosity like water, flowable semi-solid liquids, highly viscous materials or anywhere in between.

A need exists for a useful syringe tip that is capped to prevent premature exposure of the material enclosed in the syringe. The cap should be tight enough to prevent its accidental removal during shipping, transport or storage and until such time as required by the user.

### DISCLOSURE OF THE INVENTION

It is therefore, an object of the invention to provide a syringe tip.

It is another object of the invention to provide such a tip that is capped.

It is an additional object of the invention to provide such a syringe tip wherein the cap is improved in its ability to remain affixed to the tip until purposefully removed by a user.

These and other objects of the invention, which will become apparent from the present discussion, are accomplished by the invention as herein described and claimed.

In general, a syringe tip has an inlet and an outlet orifice, wherein the outlet orifice is provided with a plurality of cap contacting nubs. The syringe tip is also provided with a cap having an interior dimension such that when the cap is placed onto the syringe tip in the capped position, at least one of the nubs frictionally and physically contacts the interior of the cap.

In another embodiment of the invention, a syringe with such a tip is placed within a sealed and openable outer container, preferably a foil bag or pouch.

### BRIEF DESCRIPTION OF THE DRAWINGS

FIG. 1 is an exploded, side elevational view of a syringe tip and cap assembly according to the present invention.

FIG. 2 is a side elevational, cross sectional view of the cap portion taken along lines 2-2 of FIG. 1.

FIG. 3 is a side elevational view of the assembly of FIG. 1 showing the cap in place, and showing the tip structure under the cap in phantom lines.

FIG. 4 is a top plan view of an alternative embodiment of the tip portion of the assembly of FIG. 1, and showing the tip in place upon a syringe and having a cap placed thereon, and showing the combination of those components in a partially broken away pouch.

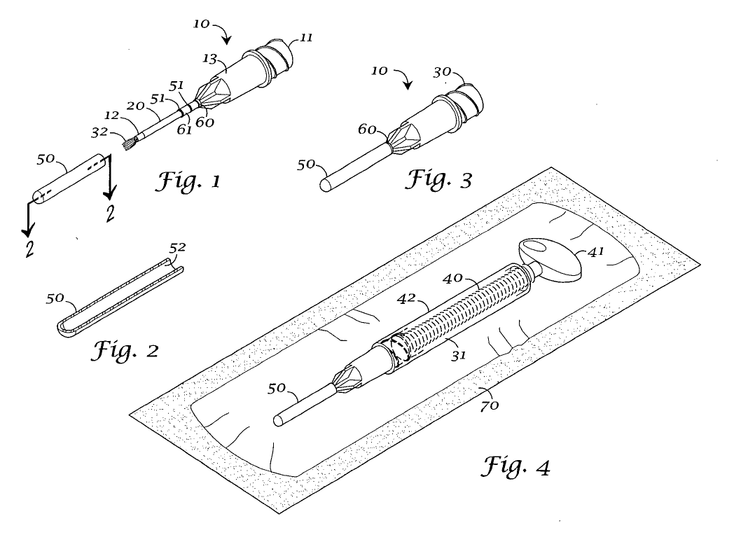

### PREFERRED EMBODIMENTS FOR CARRYING OUT THE INVENTION

In the drawings, a syringe tip according to the invention is generally designated by the number 10. Syringe tip 10 is partly of conventional design, in that it has an inlet end 11, an outlet end 12 and an elongate body 13 extending therebetween. As the terms “inlet” and “outlet” imply, in use, material enter inlet end 11, travels through body 13 and exits or is dispensed from outlet end 12.

Because a particular application of the present invention is for the dispensing of dental materials, tip 10 is preferably although optionally, provided with a reduced-size applicator portion 20 proximate to and integral with outlet end 12. One preferred configuration of tip 10 is to have a tubular-shaped body 13 and a reduced-diameter tubular-shaped applicator portion 20. Of course, neither body 13 nor applicator portion 20 need be tubular, and may be square, triangular, bulbous or any other shape. Applicator portion 20, because of its reduced size, makes precise ingress into the oral cavity easier.

According to the invention, tip 10 is provided with a connector assembly 30 for connection to a syringe, an exemplary syringe being shown by way of example by the number 31 in FIG. 4. Although connector assembly 30 is shown as being a threaded or a Leur lock, any other conventional connector means is within the scope of the invention. Further, tip 10 may be integrally molded with a syringe, although this is not shown in the drawings. Tip 10 may also be provided with a flocculent or brush 32 proximate to outlet end 12. Optional brush 32 helps facilitate the precise application of the material (not shown) expressed from tip 10.

Exemplary syringe 31 is depicted as being of the type having a threaded piston 40 having a thumbscrew 41 and positioned within a barrel 42. As is conventional, when thumbscrew 41 is turned, piston 40 advances toward or away from affixed tip 10, depending upon the direction it is turned. If piston 40 is caused to advance towards tip 10, then it will push along any material contained in barrel 42. Sufficient movement of piston 40 in this manner will physically contact and cause the material to advance into inlet end 11 of tip 10, through body 13 and to be eventually dispensed out through outlet end 12. As is conventional, the material (again, not shown) to be dispensed may be contained within barrel 40, tip 10 or both prior to it being dispensed.

Also according to the invention, tip 10 is provided with a cap 50 that will cove and close outlet end 12. Because the materials with which tip 10 will be used are often volatile, such as with dental materials, a tight fitting and secure capping is beneficial. Therefore, cap 50 is configured to cooperate with certain structure of tip 10 to improve the fitting and retention of cap 50 thereto until intentionally removed by a user. The cooperating elements between and other elements of cap 50 and tip 10 will now be described.

Tip 10 is provided with at least one a preferably a plurality of cap-retaining nubs 51. As cap 50 is fitted to tip 10 in the capped position (shown in FIG. 3) nubs 51 contact the interior surface 52 of cap 50. It is believed that the contact between nubs 51 and interior surface 52 of cap 50 provides a smaller area of contact between tip 10 and cap 50, thereby increasing the resistance to movement t that point. Hence, cap 50 is more securely held to tip 10 than would otherwise be the case.

Cap 50 is therefore, preferably configured with an interior surface 52 having a dimension slightly less than the outer dimension of nubs 51. More preferably, both tip 10, its integrally formed nubs 51 and cap 50 are fabricated from a hard plastic material such that as cap 50 is placed onto tip 10, the interior surface 52 and/or nubs 51 slightly deform due to the physical contact therebetween. This slight deformity further serves to securely hold cap 50 to tip 10. The secure contact is maintained until a user applies a force to cap 50 to intentionally remove cap 50 from tip 10.

Cap 50 is also preferably configured to have a lengthwise dimension sufficient to cover outlet end 12, and to extend to or even beyond the position of nubs 51. Tip 10 may also be provided with a seat 60 preferably positioned between body 13 and outlet end 12, or if applicator portion 20 is employed, between it and body 13. Cap 50 is then configured to have a lengthwise dimension sufficient to enclose outlet end 12, applicator portion 20 and nubs 51, and further to extend to and physically contact seat 60. The physical contact between cap 50 and seat 60 is preferably substantially liquid-tight when made, although this is not necessarily required. Likewise, the physical contact between nubs 51 and cap 50 is also preferably liquid-tight. By “liquid-tight” as use herein, it is meant of sufficient physically contact such that the material used with the given tip 10 cannot pass between the physical contact under the standard or normal conditions with which the tip 10 is made, transported, stored, used or otherwise employed.

A preferred configuration of nubs 51 is to be circumferential, surrounding a tubular portion of tip 10. Of course, if the portion of tip 10 carrying nubs 51 is not tubular (not shown) then nubs 51 will not be circular either, but will conform to the exterior shape of that portion of tip 10 supporting them.

It has been found that a preferred configuration of the present invention, has an intermediate-sized portion 61 positioned between body 13 and outlet end 12, or between body 13 and applicator portion 20 if used, that carries or supports nubs 51. Intermediate portion 61 improves the strength of the physical contact between cap 50 and tip 10. Further, it is often the case that applicator portion 20 may be fabricated to be at least somewhat flexible to assist in the precise application of the given material. In order to ensure a tight and secure fit and contact between tip 10 having such a flexible applicator portion 20 and cap 50, a relatively inflexible intermediate-sized portion 61 may be employed. Also, it is preferred that all portions of tip 10, including nubs 51 and except for brush 32 and cap 50, be integrally formed such as by injection molding or other conventional technique.

As shown in FIG. 4, a tip 10 or even a tip 10 affixed to a syringe 31 may be packaged in a pouch or bag 70. By being fabricated from a suitable material such as a foil, plastic or even a laminate, the freshness of the material to be dispensed is maintained.

It should be apparent therefore, that a syringe tip according to the invention, carries out the objects of the invention as above set forth and otherwise contributes to the advancement of the art. The present invention has been described and depicted for exemplary purposes only, without attempting to show all of the various alternative embodiments that will be apparent to the person of ordinary skill. Therefore, the scope of the invention will be determined only by the accompanying claims.

1. A syringe tip for use in dispensing a viscous dental material from a dispensing syringe, the tip comprising:
a substantially tubular body having an inlet end and an oppositely disposed outlet end; said inlet end having a connector assembly for connecting said body to the syringe;
said outlet end integrally and fluidly communicating with a tubular applicator; said applicator being reduced in size as compared to said body;
a selectively removable cap having an interior surface such that at least a portion of said applicator is received within said cap when said cap is placed upon said syringe;
and, at least one nub element positioned on the exterior of the tip, such that when said cap is placed over said applicator, said at least one nub element frictionally and physically contacts said interior surface of said cap.

2. A tip as in claim 1, wherein said at least one nub element is substantially circumferentially positioned around said applicator, and said at least one nub element has a diameter larger than the diameter dimension of said interior surface of said cap.

3. A tip as in claim 1, wherein said applicator has an applicator outlet end; said applicator outlet end being provided with a brush.

4. A dispensing system for dispensing viscous materials comprising:
a sealed, openable outer package; a syringe and a syringe tip disposed within said package; said syringe containing the material to be dispensed; said tip comprising a substantially tubular body having an inlet end and an oppositely disposed outlet end; said inlet end having a connector assembly for fluidly communicatively connecting said body to said syringe;
said outlet end integrally and fluidly communicating with a tubular applicator; said applicator being reduced in size as compared to said body;
a selectively removable cap having an interior surface such that at least a portion of said applicator is received within said cap when said cap is placed upon said syringe;
and, at least one nub element positioned on the exterior of the tip, such that when said cap is placed over said applicator, said at least one nub element frictionally and physically contacts said interior surface of said cap.
